(19) United States
(12) Patent Application Publication
(10) Pub. No.: US 2005/0093762 A1
(43) Pub. Date: May 5, 2005

(54) Breakaway antenna

(76) Inventor: Steve J. Pick, Polson, MT (US)

Correspondence Address: DICKSTEIN SHAPIRO MORIN & OSHINSKY LLP, 2101 L Street, NW, Washington, DC, 20037, US

(21) Appl. No.: 10/700,526

(22) Filed: Nov. 5, 2003

(51) Int. Cl. H01Q 1/12

(52) U.S. Cl. 343/878

(57) ABSTRACT

An antenna mount includes a frame formed by a front plate and a rear plate connected by a separator, which has a concave seat centrally located on its upper surface. A rotator element is pivotally secured between the front and rear plates, and is rotatable either clockwise or counterclockwise through the support frame. The upper portion of the rotator has a threaded opening into which an antenna can be mounted, while a spring mounted piston is provided at the bottom end of the rotator. When an antenna is mounted in the rotator and is upright, the piston is securely engaged on the seat. The antenna mount is installed on a vehicle so that upon encountering an obstacle while moving either forward or backward, the spring mounted piston becomes disengaged from the seat, causing the rotator and antenna to pivot either forward or backward in response to the force. The antenna can be reset by lifting the antenna until the antenna mount returns to a locked position and the antenna is again upright.

### FIELD OF THE INVENTION

The present invention relates to a mounting device for antennas, and more particularly for antennas used on vehicles which use tall antennas.

### BACKGROUND OF THE INVENTION

A typical aerial antenna mounted to the exterior body of the vehicle is constructed as a series of concentric segments which allow the antenna to be extended to a maximum length by “stretching” the antenna so that its segments are linearly arranged, and to be retracted by collapsing the segments down to the length of one segment. This type of construction, while acceptable for light duty antennas such as the antennas found on many cars, it is unsuitable for the large, heavy duty antennas mounted on military vehicles. As military equipment becomes more sophisticated and more reliant on radio or other airwave transmissions, more and more equipment are requiring mounted antennas mounted on the vehicles. Such military antennas are typically at least 15-20 feet tall and 1.5″ or larger in diameter at the base of the antenna. Thus, the mounting devices for mounting the antennas to the vehicles must be designed not only to be extremely strong to support such a large antenna, but also to withstand a significant amount of abuse, including extreme weather conditions and other elements of the environment that may be encountered in the field during military operations.

When a heavy duty type antenna is mounted on a moving military vehicle and the antenna encounters an obstruction overhead of the vehicle, the impact of the antenna against the obstruction will cause the antenna to break. Although several different types of mounting devices and other protection devices have been developed to prevent antenna breakage due to obstructions, the designs are generally suitable only for light duty antennas and cannot withstand the size and conditions associated with military antennas. Accordingly, there is a need for an antenna mount which is suitable for use in military applications and which protects the antennas from breakage upon impact.

### SUMMARY OF THE INVENTION

The present invention provides an antenna mount which secures an antenna in an upright position while allowing the antenna to become disengaged from the upright position when the antenna encounters a low barrier or low clearance. Upon such impact, the antenna mount pivotally swings the entire antenna in the direction of impact. The antenna can then be reset by lifting the antenna until the antenna mount returns to a locked position at which the antenna is once again in an upright position.

The antenna mount generally includes a front plate and a rear plate connected by a separator piece to form a support frame. The separator has a seat centrally located on the upper surface thereof. A rotator element is pivotally secured between the front plate and rear plate, and is configured to be rotatable either clockwise or counterclockwise. Additionally, the rotator is structured to enable an antenna to be mounted at the upper portion thereof, and includes spring mounted piston at the bottom thereof.

When an antenna is mounted in the rotator and is upright, the piston at the bottom of the rotator is securely engaged on the seat provided on the separator. The antenna mount is installed on a vehicle so that upon encountering a lateral force in either the forward or backward direction relative to the direction of movement of the vehicle, the spring mounted piston is forced off the seat, whereupon the rotator and antenna pivots forward or backward in response to the lateral force applied against the antenna.

These and other features and advantages of the invention will become apparent from the following detailed description, which is provided in connection with the accompanying drawings and illustrate an exemplary embodiment of the invention.

### BRIEF DESCRIPTION OF THE DRAWINGS

FIG. 1 is a perspective view of the antenna mount according to the present invention;

FIG. 2 is an exploded view of the invention shown in FIG. 1;

FIG. 3 shows the rotator and bottom element of the invention shown in FIG. 1;

FIG. 4 is a side view of the rotator and bottom element shown in FIG. 3;

FIG. 5 is a front view of the rotator and bottom element shown in FIG. 3;

FIG. 6 is a cross-sectional view through the line VI-VI in FIG. 1;

FIG. 7 is a cross-sectional view through the line VII-VII in FIG. 1;

FIG. 8 shows the antenna mount of the present invention with the rotator rotated in a counterclockwise direction;

FIG. 9 shows the antenna mount of the present invention with the rotator rotated in a clockwise direction;

FIG. 10 shows a frame for securing the antenna mount to a vehicle.

### DETAILED DESCRIPTION OF THE PREFERRED EMBODIMENTS

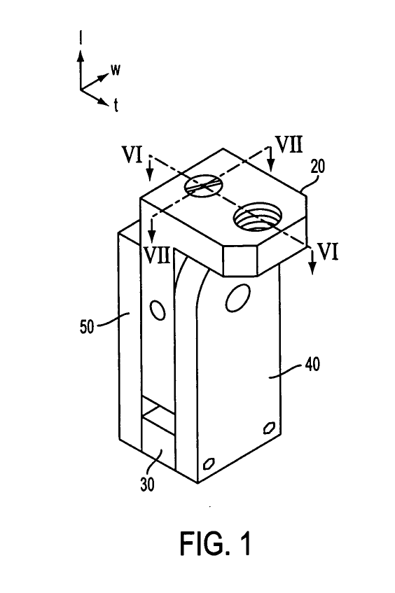

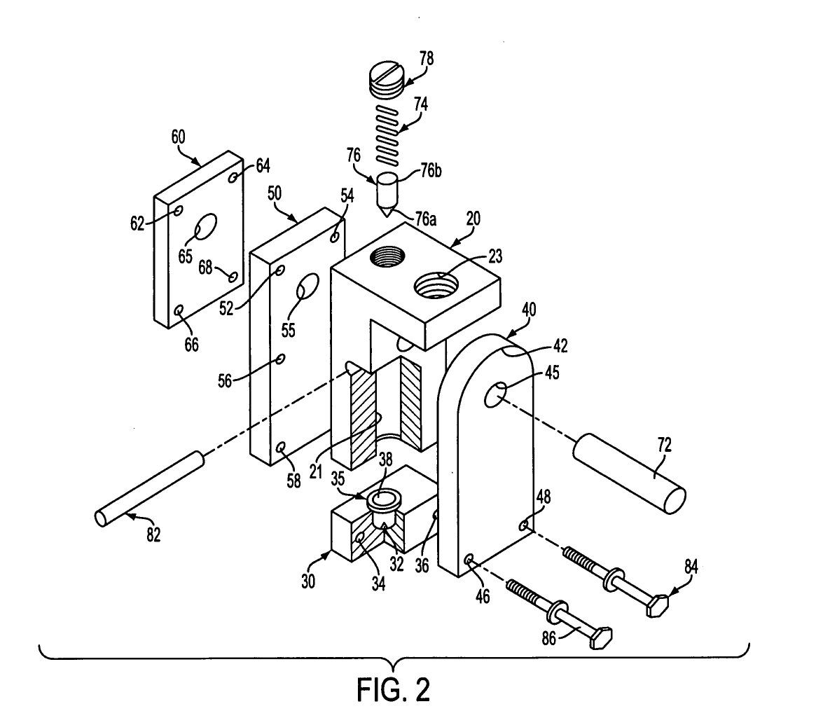

FIG. 1 shows an antenna mount 10 according to an embodiment of the present invention, while FIG. 2 shows an exploded view of the antenna mount 10. Generally, the antenna mount 10 includes a front plate 40, a back plate 50, a separator 30 and a rotator 20.

As best seen in FIG. 2, front plate 40 has a pivot bore 45 formed through the thickness of the plate at an upper region thereof, and two parallel bores 46, 48 formed through the plate and near the bottom corners of the plate. Preferably, though not necessarily, the upper end of the front plate 40 has a rounded contour 42.

The structure of the back plate 50 is similar to that of the front plate 40 in that the back plate 50 also has a pivot bore 55 extending through the thickness of the plate and a pair of parallel bores 58 (only one shown in FIG. 2) formed through the plate near the bottom corners thereof. Additionally, back plate 50 also includes two additional pairs of bores 52, 54 and 56 (only one shown in FIG. 2).

As illustrated in FIGS. 2-5, the separator 30 has a shallow hole 33 formed at the center of the top surface thereof, and a pair of parallel bores 34, 36 extending through the separator 30 in the direction “ts” (FIGS. 1, 4). The bores 34, 36 of the separator 30, the bores 46, 48 of the front plate 40 and the bores 58 of the back plate 50 are formed so as to become aligned to form one continuous bore when the separator is sandwiched between the front and back plates. A seat 35 having a cylindrical bottom portion and a concave disc portion 38 is affixed in the separator with the cylindrical portion fitted into the hole 33 and the concave disc 38 flush with or having an outer periphery thereof sitting directly on the upper surface of the separator 30. Optionally, the concave disc portion 38 may include a lip around the periphery of the disc.

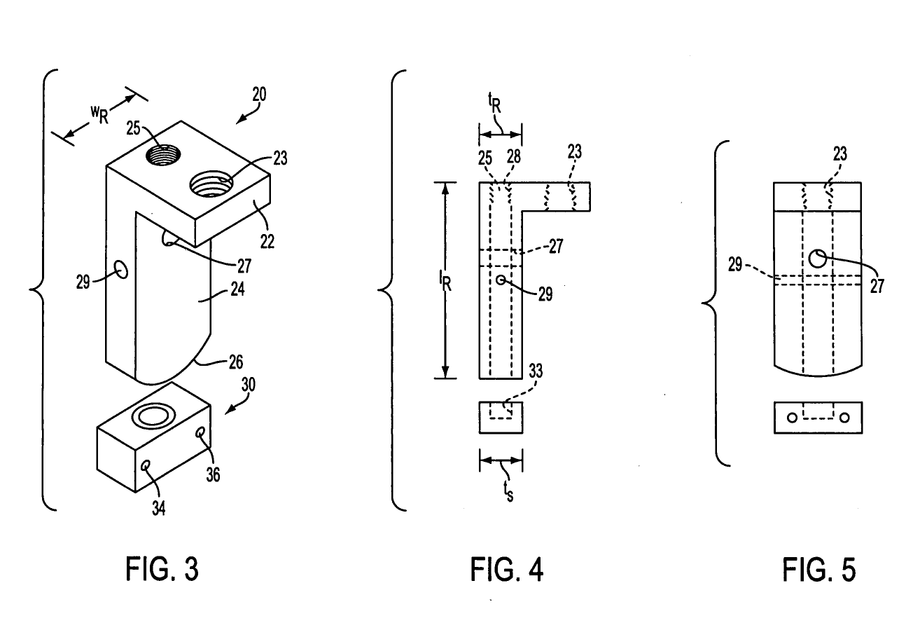

Rotator 20, as best seen in FIGS. 3-5, is generally shaped like an upside-down “L,” with the horizontal portion being formed as a mounting platform 22 and the vertical portion forming a pendulum section 24 of the rotator. The lower end 26 of the pendulum section 24 preferably has a rounded contour to allow the rotator to rotate as will be described further on in this description of the invention.

A threaded antenna bore 23 is formed through the overhanging plane of the mounting platform 22 for engaging the base portion of an antenna (not shown). Although it is preferable to have the threaded antenna bore 23 formed all the way through the mounting platform 22, it is not necessary to do so, as the threaded antenna bore 23 may be formed only partially through the mounting platform 22. Furthermore, the present invention may be provided with other suitable types of mechanisms or arrangements instead of a threaded antenna bore 23, for securing an antenna to the rotator 20, such as a clamp, matingly shaped connectors on the antenna and the rotator, adhesives, etc.

In addition to the antenna bore 23, rotator 20 also provides a spring bore 25 formed centrally through the entire length of the pendulum section 24 and which is threaded at the top end 28 thereof. A pivot bore 27 is formed perpendicularly to spring bore 25, along the direction “tR” through the pendulum section 24. A pin bore 29 is formed perpendicularly to both the spring bore 25 and pivot bore 27, along the direction “wR” of the pendulum section 24. Both pivot bore 27 and pin bore 29 intersect and pass through spring bore 25, but are spaced apart from each other along the length “lR” of the spring bore 25 with pin bore 29 being positioned slightly below the pivot bore 27.

Although the pin bore 29 is described in the exemplary embodiment as extending along the direction “wR” of the pendulum section 24 and perpendicular to the pivot bore 27, it is not necessary to orient the pin bore 29 in this manner. Alternatively, pin bore 29 may be formed parallel to the pivot bore or along any other desired angle to pivot bore 27, as long as the pin bore 29 is located below the pivot bore 27. Furthermore, the pin bore 29 is shown in the figures as extending through the entire width of the pendulum section 24, but it can be formed to be shorter as long as it intersects and passes through the spring bore 25.

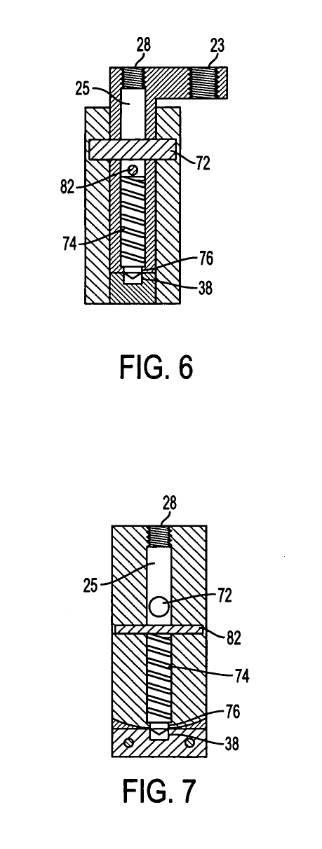

As can be seen from FIGS. 2 and 6-7, a spring and piston assembly are placed in the spring shaft 25 with the tip 76a of the piston 76 protruding from the rounded bottom of the pendulum section 24. The bottom end of spring 74 contacts or may be frictionally fit around the cylindrical portion 76b of the piston 76. Both the diameter of the cylindrical portion 76b of piston 76 and the outer diameter of the spring are sufficiently smaller than the diameter of the spring bore 25 so that the spring 74 can be compressed freely without being frictionally hindered by the wall of the spring bore 25. The spring bore 25 may be formed with a shoulder or fitted with a snap ring at the bottom opening, which enables the tip 76a of the piston to protrude from the end of the spring bore 25 while preventing the piston 76 and spring 74 from slipping out of the spring bore 25. The spring 74 has a natural length at least equal to the length measured from the bottom of the spring shaft 25 to the pin bore 29.

A pin 82 is inserted into the pin bore 29 across the top of spring 76 to thus prevent the spring 76 from extending or being pushed up into the region of the pivot bore 27. The spring bore 25 is closed off at the top by a cap 78 screwed into the threaded portion at the top of the bore, so as to prevent debris from entering the bore.

Assembly of the antenna mount is achieved by aligning the bores 46, 48, 34, 36, and 58 of the front plate 40, separator 30 and back plate 50, respectively, and joining these three pieces together with a pair of bolts 84, 86 through the pair of continuous bores formed by the aligned pairs of bores through the front and back plates and the separator. When joined together, the front and back plates and the separator form a U-shaped frame.

The rotator 20, which has the spring 74, piston 76, pin 82 and cap 78 appropriately assembled in the spring bore 25, is then placed between the front and back plates in the U-shaped frame, with the piston 76 resting on the concave surface 38 of the seat 32 and the mounting platform 22 of the rotator 20 overhanging the (rounded upper end of) front plate 40.

The rotator 20 is secured to the frame by pushing down slightly on the rotator 20 to align the pivot bores 45, 27 and 55, and then inserting a shaft 72 into the aligned pivot bores. The diameters of the shaft 72 and the pivot bores 45, 27 and 55 are preferably dimensioned so that the shaft 72 is frictionally fitted into the bores 45 and 55 of the front plate 40 and the back plate 50, respectively, while the diameter of the pivot bore 27 in the rotator is slightly greater than that of pivot bores 45 and 55 so that rotator 20 can pivot readily around the shaft 27. Optionally, the ends of the shaft 27 may be even more securely affixed in the bores 45 and 55 using adhesives, welding, and/or other means. Also, the diameters of bores 45 and 55 can be made to be equal to the diameter of bore 27, perhaps for simplifying the manufacture of the component parts in the device.

When the rotator 20 is pushed down on the separator 30 and then held in this position by the shaft 72, the spring 74 becomes slightly compressed and the piston 76 is pressed against the concave surface 38 of the seat 32. By biasing the piston against the seat 32, this position of the rotator 20 becomes particularly stable and requires a predetermined amount of force to move the rotator 20 out of this position, which depends on the spring constant k. The higher the spring constant k, the “stiffer” the spring becomes, which causes the piston 76 to press harder against the seat 38, which in turn requires a greater force to overcome this force to push the piston 76 off the seat 38. If the seat 38 is formed with the optional lip around the periphery thereof, the piston engages the seat even more stably. When the piston 76 is in this stable arrangement with the seat 38, the rotator 20, and hence any antenna mounted in the antenna bore 23, are in the upright position.

When an antenna is mounted in the antenna mount 10 and the antenna encounters an obstruction or lateral force sufficient to overcome the bias force of the spring 74 pushing the piston 76 against the seat 38, the piston 76 is pushed off the seat 38 as the rotator pivots around shaft 72 in the direction of the force. The amount of force required to disengage the piston can be tailored to a desired or predetermined level by using a spring having the appropriate spring constant k. Once the piston is disengaged off the seat 38, the antenna falls to a horizontal position to safely clear the source of the lateral force without bending or breaking the antenna. The antenna can be easily restored to the upright position by raising the antenna until the piston “snaps” back into position on the seat 38.

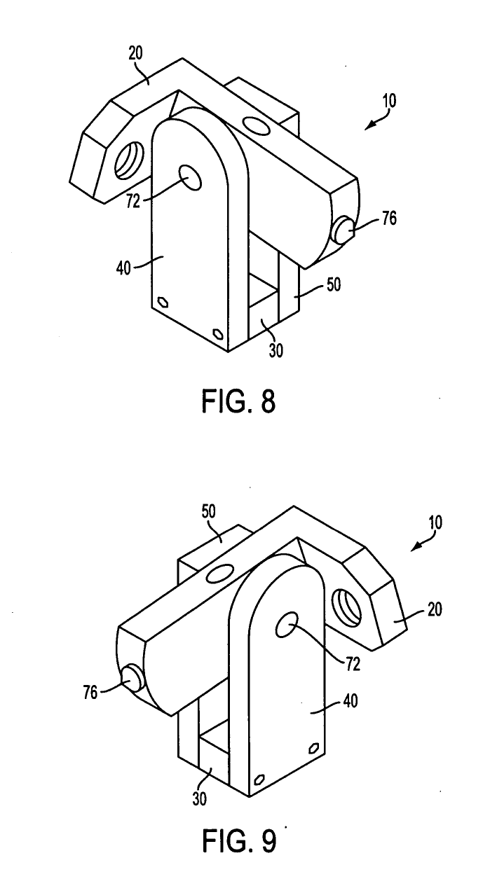

As shown in FIGS. 8 and 9, the rotator is capable of pivoting either clockwise or counterclockwise around the shaft 72. Such capability is advantageous in that when the antenna mount is mounted to a vehicle, the antenna can be protected from breakage upon encountering any obstacle, no matter if the vehicle is moving forward or backward.

The antenna mount may be constructed of an anticorrosive and lightweight but sturdy material, such as aluminum or aluminum alloys, or a high tensile strength industrial plastic. The sturdy design of the antenna mount easily enables the device to accommodate the 15-20+ ft. height of military antennas and to withstand harsh and abusive environments and conditions, while the relatively simple structure reduces the possibilities for failure or breakage, and are easy to maintain and/or repair should it become necessary.

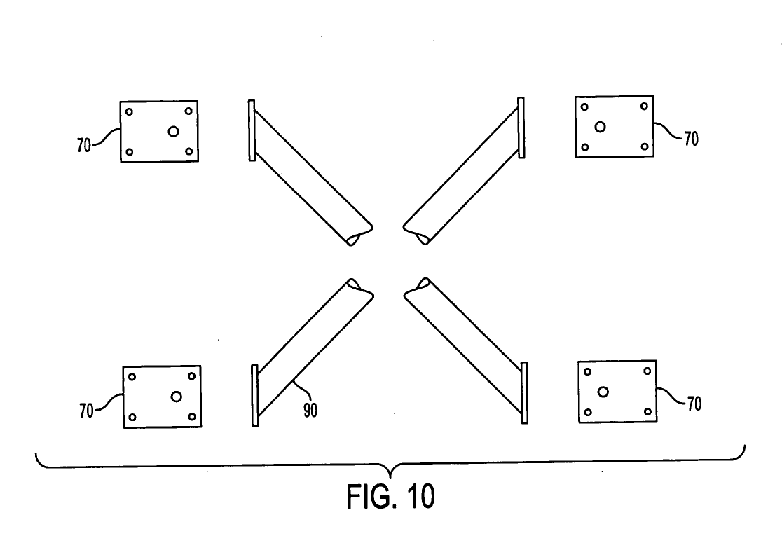

A military vehicle will often require the use of several antennas, thus requiring that several of the antenna mounts be affixed to the vehicle. A typical arrangement for securing the antenna mount to the vehicle is shown in FIG. 10. The frame 90 is a part of a telescoping antenna base which is raised to receive and transmit signals. The frame includes a plurality of brackets 60, as also shown in FIG. 2.

Each bracket 60 includes a plurality of throughholes 62, 64, 66, 68 for screwed or bolted to the back plate 50 of the antenna mount. For this purpose, back plate 50 also includes a corresponding set of throughholes 52, 54, 58 (one note shown) formed in alignment with the positions of the throughholes formed in the bracket 60. Preferably, each bracket 60 also includes a pivot bore 65 formed in alignment with the bores 55, 27 and 45 of the back plate 50, the rotator 20 and the front plate 40. With the pivot bore 65, the pivot shaft 72 may be inserted beyond the back plate 50 into the bracket 65, which provides for even more stability in securing the antenna mount to the vehicle and in supporting the weight of the antenna.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. An antenna mount comprising:
a U-shaped support frame having a front portion, a back portion, and a bottom portion connected between the front and back portions, the bottom portion having a concave seat formed centrally on the interior surface of the U-shaped frame; and
a rotator element pivotably supported between the front portion and the back portion of the U-shaped frame, the rotator element including
a pendulum portion extending between the front and back portions,
a spring-biased piston provided at the bottom of the pendulum portion, wherein the piston is spring biased to be securely engaged in the seat when the pendulum portion is in parallel alignment with the front and back portions of the U-shaped frame, and
a connector for receiving and engaging an antenna.

2. The antenna mount according to claim 1, wherein the pendulum portion has a rounded contour at its bottom end.

3. The antenna mount according to claim 1, wherein the rotator element is shaped as an upside-down “L”, and the connector is formed in a portion of the L-shaped rotator which overhangs the front portion of the frame.

4. The antenna according to claim 3, wherein the connector is a threaded bore formed through the overhang portion of the L-shaped rotator.

5. The antenna mount according to claim 3, wherein the front portion of the frame has a rounded profile at its upper end.

6. The antenna mount according to claim 1, wherein the rotator element further includes
a first bore formed centrally through the length thereof,
a second bore formed perpendicularly to and intersecting the first bore,
a coil spring located in the first bore having a length at rest at least equal to a portion of the length of the first bore, as measured from the bottom of the pendulum portion to the location along the first bore at which the second bore intersects the first bore,
a pin inserted into second bore to prevent the spring from moving upwards in the first bore, and
wherein the piston is secured to one end of the spring and protrudes from the bottom of the pendulum portion.

7. The antenna mount according to claim 6, wherein the spring has a spring constant such that the piston becomes disengaged from the seat when the rotator rotates in response to a predetermined force applied against the antenna.

8. The antenna mount according to claim 6, further comprising an end cap removably fixed in the top of the first bore.

9. The antenna mount according to claim 1, wherein the rotator element is rotatable either clockwise or counterclockwise.

10. The antenna mount according to claim 1, wherein the front portion and back portion of the U-shaped support frame are individual plates formed separately from the bottom portion, the front portion, back portion and bottom portion being secured together to form the U-shaped frame.

11. The antenna mount according to claim 1, wherein the antenna mount is suitable for use with military antennas and under military operating conditions.

12. An antenna mount comprising:
a front plate;
a back plate;
a separator element having a concave seat formed thereon, the separator element being connected between the front plate and the back plate;
a rotator element having a pendulum portion and an antenna mounting platform, the pendulum portion being pivotably mounted between the front plate and back plate and the antenna mounting portion overhanging over the front plate;
a pivot shaft extending through the front plate, the pendulum portion of the rotator element and the back plate to thereby pivotably mount the rotator element; and
a spring-biased piston provided at the bottom of the pendulum portion of the rotator element, such that when the pendulum portion is aligned with the front plate and the back plate, the piston is securely fixed in the concave seat via a force exerted by the spring-biased piston pushing against the seat.

13. The antenna mount according to claim 12, wherein the bottom of the pendulum portion on which the piston is provided has a rounded contour and wherein the rotator element is rotatable both clockwise and counterclockwise around the pivot shaft.

14. The antenna mount according to claim 12, wherein the rotator element is held in an upright position by the spring-biased piston engaged with the concave seat, and wherein a predetermined level of torque force applied to the rotator element causes the piston to disengage from the seat.

15. The antenna mount according to claim 14, wherein the rotator element can be restored to the upright position by rotating the rotator element until the piston automatically engages the seat once the rotator element reaches the upright position.

16. The antenna mount according to claim 12, wherein the rotator element further includes
a spring bore formed through the length of the pendulum portion,
a pin bore formed perpendicularly to and intersecting the spring bore,
a coil spring having a length at rest at least equal to the length of a portion of the spring bore, as measured from the bottom of the pendulum portion to the location along the spring bore at which the pin bore intersects the spring bore, the spring being positioned in the spring bore, and
a pin inserted into the pin bore to prevent the spring from moving upwards in the first bore,
wherein the piston is secured to one end of the spring and protrudes from the bottom of the pendulum portion through the spring bore.

17. The antenna mount according to claim 16, further comprising an end cap removably fixed in the top of the spring bore.

18. The antenna mount according to claim 12, wherein the front plate has a rounded contour at an upper end thereof.

19. The antenna mount according to claim 12, wherein the back plate is configured to be attachable to a bracket for mounting on a military vehicle.

20. The antenna mount according to claim 12, wherein the antenna mounting portion of the rotator element includes a threaded throughhole for engagedly receiving an antenna.
